(19) United States
(12) Patent Application Publication
(10) Pub. No.: US 2005/0126549 A1
(43) Pub. Date: Jun. 16, 2005

(54) Ventilation system for a fuel tank of an internal combustion engine

(76) Inventor: Frank Reiners, Walblingen (DE)

Correspondence Address: WILLIAM COLLARD;COLLARD & ROE, P.C., 1077 NORTHERN BOULEVARD, ROSLYN, NY, 11576, US

(21) Appl. No.: 10/499,628

(22) PCT Filed: Dec. 17, 2002
(86) PCT No.: PCT/DE02/04607

(30) Foreign Application Priority Data
Dec. 22, 2001 (DE) 101-63-923.6

(51) Int. Cl. F02M 25/08

(52) U.S. Cl. 123/520

(57) ABSTRACT

The invention relates to a ventilation system for a fuel tank of an internal combustion engine, the device comprising a filter. The aim of the invention is to functionally improve one such device, simultaneously reducing the structural volume thereof by saving filter volume. To this end, the inventive device is characterized by at least one of the following features: a first stop valve leading to the atmosphere communicates with the same via an air intake filter of the internal combustion engine; and the inner chamber of the tank and the air-guiding region located between the tank and the stop valves are connected to a pump which sucks air from the atmosphere into said region via the air intake filter of the internal combustion engine, if one such pump is available.

This invention relates to a ventilation system for a fuel tank of an internal combustion engine according to the definition of the species of Patent claim 1.

Such a system in which the pump is situated in the section carrying the return air from the adsorption filter to the air intake area of the internal combustion engine is known from German Patent DE 198 29 423 A1. With this system, an air intake filter must be connected upstream from the pump on the air intake side, its only function being to filter the intake air of the pump.

The pressure-measuring device used with the generic system serves to test the air carrying region from the interior of the tank to the cutoff valves (when these valves are closed) for leakage in this area. When a pump is present, this pressure-measuring device is integrated into the pump in particular, so that an excess pressure can be built up by the pump in the aforementioned system in the area to be tested for leakage. When performing the pressure measurement, a medium flows through a fine throttle bore, among other things. This fine throttle bore must be protected from blockage due to soiling, so a filter having a relatively high degree of separation is necessary on the intake side of the pump. The pump itself must also be protected from soiling to a high degree. A high degree of separation also means a high pressure drop and a large filter area if the latter is not to become too great because of this high pressure drop.

This invention is concerned with the problem of managing with the smallest possible number of filters or with filters that do not have a particularly high degree of separation for supplying atmospheric air into the region between the interior of the tank and the closed cutoff valves. For the case when the internal combustion engine sucks in its combustion air through an intake air filter which is combined with an activated carbon filter, the air coming out of the tank and passing through the activated carbon filter connected to the tank must additionally flow through the activated carbon filter combined with the intake air filter of the internal combustion engine before entering the atmosphere.

The problem described above is solved with a generic system through the design according to the characterizing features of the Patent claim 1.

Expedient and advantageous embodiments of this invention are the object of the subclaims and are explained in greater detail below on the basis of an exemplary embodiment.

The drawing in the single figure shows

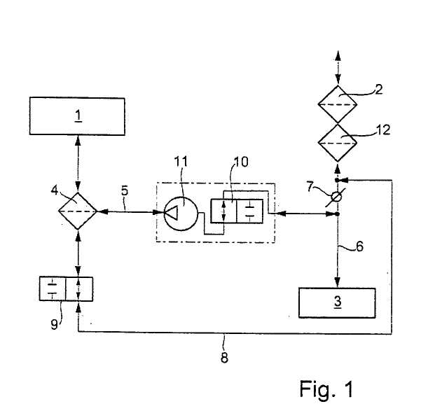

FIG. 1 a ventilation system for the fuel tank of an internal combustion engine, shown in a schematic diagram.

A tank 1 is connectable to the atmosphere via an adsorption filter 4 and an intake air filter 2 of an internal combustion engine 3. Between the tank 1 and the adsorption filter 4, which may be an activated carbon filter, valves that are essentially known with tank ventilation systems such as a pressure holding valve (not shown here) which acts with respect to the tank 1, are provided.

The adsorption filter 4 can be backwashed for regeneration by connecting it via a line 5 to the air intake area of the engine 3, which is an area between the intake air filter 2 and the engine 3. With such a backwashing, which is performed at certain intervals and/or when a certain load limit of the adsorption filter is detected, fresh air from the atmosphere is passed through the air filter 2 by means of the intake air into the internal combustion engine 3. In the air intake line 6 of the internal combustion engine 3, there is an intake throttle valve 7 such as those conventionally used with an engine. The fresh air to be introduced from the atmosphere in backwashing the adsorption filter 4 through a flow line 8 via the intake air filter 2 is drawn in upstream from the throttle valve 7 with respect to the internal combustion engine 3. Furthermore, the fresh air is drawn into the air intake line 6 in an area downstream from the throttle valve 7 with respect to the internal combustion engine 3 in backwashing the adsorption filter 4.

The adsorption filter 4, including an area extending into the tank 1, can be cut off airtight with respect to the atmosphere and with respect to the intake line 6 of the internal combustion engine 3 by a first cutoff valve 9 accommodated in the line 8 and a second cutoff valve 10 accommodated in the line 5. Such a cutoff makes it possible to test the air-carrying region for leakage between the tank 1 and the cutoff valves 9 and 10.

One possibility for such a leakage test is to put the respective area under an excess pressure with respect to atmospheric pressure by means of a pump 11 when the cutoff valves 9 and 10 are closed. This space, which is under an excess pressure, can then be tested for leakage by a pressure-measuring device (not shown in the diagram) which may be integrated into the pump 11 and is then connected to the space to be tested. The pump 11 sucks in the air necessary to achieve the excess pressure and to be introduced into the room to be tested from the air intake line 6 at a location downstream from the throttle valve 7.

With respect to the internal combustion engine, an intake air adsorption filter 12 is connected downstream from the air intake filter 2. This intake air adsorption filter 12 may be, for example, a nonwoven material impregnated with activated carbon.

The intake air adsorption filter 12 serves first of all to remove any environmental pollutants from the intake air flowing back out of the air intake filter 2 into the atmosphere when the internal combustion engine 3 is shut down, and secondly, in the case of tank ventilation through the line 8, it provides an additional treatment going beyond that provided by the adsorption filter 4 for the air leaving from the tank 1 into the atmosphere through a downstream additional activated carbon filter. Therefore, the activated carbon filter 4 may either be designed to be of a smaller volume, or with the same design, it may provide an increased reliability with respect to emission of pollutants together with the air escaping from the tank 1 into the atmosphere.

This invention also achieves a substantial advantage when the first cutoff valve 9 is not connected to the intake air line 6 on the atmosphere end. In this case, the first cutoff valve 9 on the atmosphere end is sufficient as a simple valve protection filter if the pump 11 can draw in intake air through the air intake filter 2 and the pressure-measuring device for the leakage test is in the area of the pump 11, i.e., in an area where it is reliably protected by the air intake filter 2 from dirt penetrating from the atmosphere.

A leakage test on the air carrying area between the tank 1 and the cutoff valves 9 and 10 may also be performed without the use of a pump 11 by creating a reduced pressure in this area through the combustion air flowing into the internal combustion engine 3 in an essentially known manner. In this case, the second cutoff valve 10 is also closed after reaching a reduced pressure in comparison with the atmosphere in the space to be tested and then a possible pressure increase is detected as a sign of leakage with a pressure-measuring device which is likewise already known for such a purpose. In the absence of a pump 11, the advantage to be achieved through this invention consists of connecting the first cutoff valve 9 to the atmosphere via an air intake filter 2 combined with an intake air adsorption filter 12.

1. A ventilation system for the fuel tank (1) of an internal combustion engine (3), in which
a) the ventilation passes through an adsorption filter (4),
b) the adsorption filter is regenerable by backwashing with atmospheric air,
c) the backwashing air is supplied to the air intake area of the internal combustion engine (3),
d) the connections leading from the adsorption filter (4) on the one hand to the atmosphere and to the intake area of the internal combustion engine (3) on the other hand can be interrupted by a first and second cutoff valve (9, 10),
e) the interior of the tank (1) and the air carrying area between the tank (1) and the cutoff valves (9, 10) is connected to a pressure-measuring device for determining the pressure inside this entire area containing air when the cutoff valves (9, 10) are closed,
f) a pump (11) may be provided in the area carrying the backwashing air between the adsorption filter (4) and the intake area of the internal combustion engine (3), so that with the help of this pump, fresh air from the atmosphere can be introduced into the area between the tank (1) and the cutoff valves (9, 10),
characterized by at least one of the following features:
g) the first cutoff valve (9) leading to the atmosphere is in a line (8) which leads from the adsorption filter (4) through the air intake filter (2) of the internal combustion engine (3) to the atmosphere, through which a connection to the atmosphere is possible only through the air intake filter (2),
h) if a pump (11) is present, it is connected to the atmosphere via the air intake filter (2) of the internal combustion engine (3).

2. The system according to claim 1, wherein an intake air adsorption filter (12) is connected from the engine air intake filter (2) downstream with respect to the engine intake air flowing through this filter.

3. The system according to claim 2, wherein the intake air adsorption filter (12) is integrated into the intake air filter (2).

4. The system according to claim 2, wherein the intake air adsorption filter (12) is an activated carbon filter.

5. The system according to claim 3, wherein the intake air adsorption filter (12) is designed in the form of a nonwoven material.

6. The system according to claim 2 wherein the intake air adsorption filter (12) is detachably connected to the air intake filter (2).
